(19) United States
(12) Patent Application Publication
(10) Pub. No.: US 2009/0309720 A1
(43) Pub. Date: Dec. 17, 2009

(54) APPARATUS FOR THE DETECTION OF THE STACKED STATE OF A CONTAINER

(76) Inventor: Rainer Koch, Fuchshain (DE)

Correspondence Address: MILDE & HOFFBERG, LLP, 10 BANK STREET, SUITE 460, WHITE PLAINS, NY, 10606, US

(21) Appl. No.: 12/448,179

(22) PCT Filed: Dec. 14, 2007
(86) PCT No.: PCT/DE2007/002276

§ 371 Date: Aug. 17, 2009

(30) Foreign Application Priority Data
Dec. 14, 2006 (DE) 10 2006 059 000.7

(51) Int. Cl. G08B 21/00

(52) U.S. Cl. 340/540

(57) ABSTRACT

A device for detecting the stacked state of a container comprises a solar unit (1) that is connected to a charging unit (4) which supplies power to a locating device (7). The locating device (7) includes a transmitter (8) and a receiver (9) that communicate with a control center. A measuring device (10) is also provided which is used as a light indicator and generates an activation signal when the device is exposed to sunlight or daylight and the container is thus in a non-stacked state. The measuring device (10) supplies the activation signal to a CPU (12) that sends a non-stacked state signal to the locating device (7). The measuring device (10) feeds a deactivation signal to the CPU (12) when the device is dimmed. The CPU (12) sends a stacked-state signal indicating the stacked state of the container to the locating device (7) when the measuring device (10) determines that the device remains dimmed beyond the regular nighttime darkness. The transmitter (8) of the locating device (7) transmits the signals corresponding to the stacked state or the non-stacked state of the container to the control center.

The present invention relates to a device for detecting the stacking state of a container as set forth in the main subject of Patent claim 1.

DE 10 2004 059 759 A1 discloses a device for monitoring containers on their transport route, where a CPU in a housing is provided for processing position signals that have been received via an antenna and for generating data to be transmitted to a control center. The housing can be attached to the wall of a container in a detachable manner. The CPU stores the position signals received during transport of the container and transmits them at predetermined times to the control center for registering the transport route of the container.

It is the objective of the present invention to create a device that allows a monitoring center to monitor a container in intermodal transport such that during its transport on ships and during its storage, e.g., in port terminals, the “container stacked” or “container non-stacked” states can be detected.

This objective is achieved by a device for detecting the stacking state of containers with the features of Patent Claim 1.

The significant advantage of the present invention is that by detecting the “container stacked” and “container non-stacked” states from a monitoring center that can be at any distance from the respective location of the container, it can be recognized in next to real time and online, when and where the container is stacked in a container stack, e.g., on a ship or in a port area. Advantageously, monitoring of the “container stacked” and “container non-stacked” states enters the container's transport logistics such that at any time, in next to real time or in retrospect the transport data of the container “route, stacked on a ship or in the harbor, period of stay at the harbor, etc.” can be checked.

An additional very significant advantage of the present device is that it operates with extremely low energy consumption.

Advantageous embodiments of the invention are described in greater detail using the figures, of which

FIG. 1 is a block diagram of the device for detecting the stacking state of a container according to the invention;

FIG. 2 shows a time diagram for explaining the invention; and

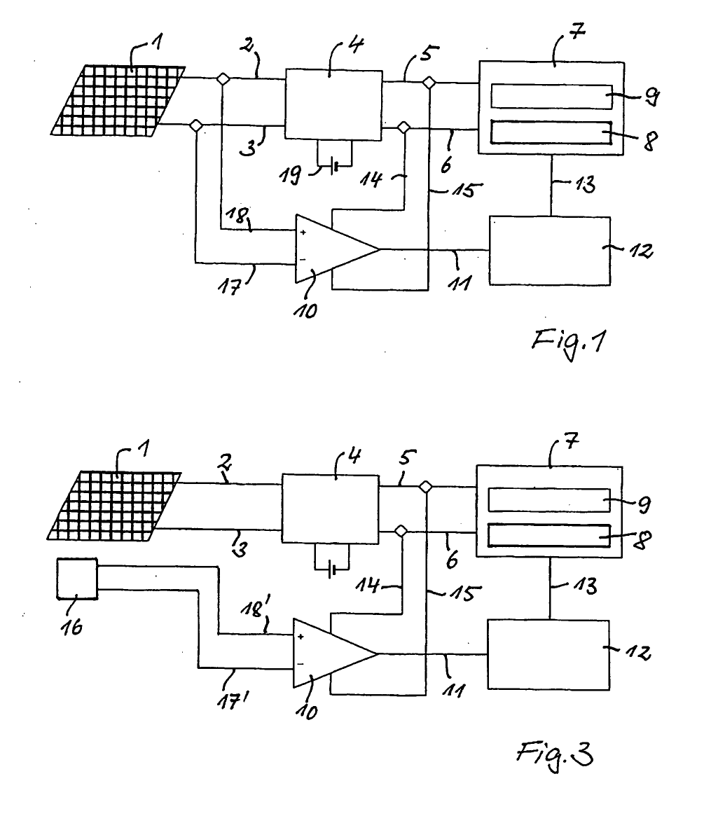

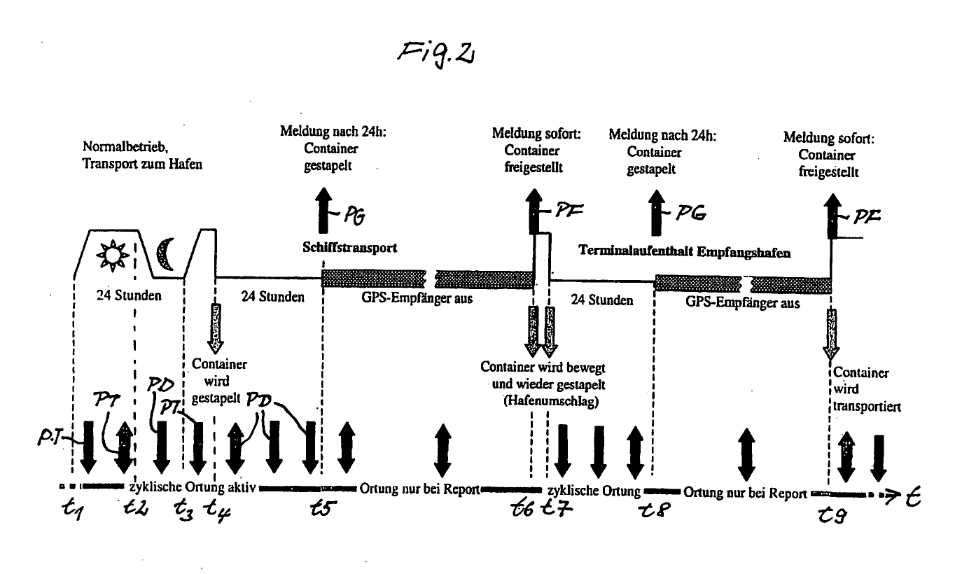

FIG. 3 is an additional embodiment of the invention.

In FIG. 1, a solar unit of the present invention is designated with the number 1. This solar unit 1 is connected to a charging unit 4 via conductors 2, 3, and said charging unit feeds a locating device 7 via conductors 5, 6. In addition, the charging unit 4 charges the rechargeable battery 19. The locating device 7 comprises a transmitter 8 and a receiver 9, for example a GPS receiver. The components or devices mentioned thus far are part of the aforementioned monitoring system of the DE 10 2004 059 751 A1 and are, therefore, known. The device 1 contained in a housing is preferably arranged in a groove of the container that is located in the upper container wall, with the housing being attached to the bottom area of said groove using magnetic elements. As a result, the daylight effects the solar unit 1 when the container stands free at any location, or is non-stacked.

According to the invention, the present device for detecting the stacking state of a container includes a measuring device 10 that detects if the solar unit 1 supplies electrical current to the charging unit 4 or not (light detection). If the measuring device 10 detects that such a current is supplied by the solar unit 1 to the charging unit 4 (activated state), it will transmit an activation signal via the conductor 11 to a CPU 12, which indicates that the solar unit 12 is exposed to sunlight or daylight, i.e., that the container is non-stacked. The CPU 12 supplies a corresponding non-stacked signal via conductor 13 to the locating device 7. Power for the measuring device 10 is supplied via conductors 14 and 15, which are connected to the output of the charging unit 4. The CPU 12 is preferably a low power micro-controller that consumes very little energy.

Because the solar unit 1 normally does not supply current to the charging unit 4 during the darkness of the night (deactivated state), and the measuring device 10 does not send a non-stacked signal to the CPU 12, the CPU 12 must be able to distinguish between a regular night condition and a state that lasts longer than the regular dim-out of the solar unit 1 during the night. Only when the CPU 12 detects that the dim-out is longer than the regular night time will a respective stacked signal be transmitted via the conductor 13 to the input of the locating device 7, indicating the “Container stacked” state because the solar unit 1 will be dimmed even during the daytime by the containers located in the stack above it.

According to the presentation of FIG. 1, the activation signal indicating the activation of the solar unit 1 is provided in the form of the output signal of the solar unit 1 via the conductors 17 and 18 to the measuring device 10. The solar unit 1 then serves as a light indicator as well.

According to the presentation in FIG. 3, it is also conceivable to receive the activation signal that indicates the activated state of the solar unit 1 from an additional light sensor 16 that is located in the area of the solar unit 1, and to supply its output signal to the measuring device 10 via conductors 17′ and 18′. In this case, the light sensor 16 serves as the light indicator.

Following, the principle of the present invention is explained in greater detail using FIG. 2, where the transport time t is plotted on the x-axis of the shown diagram, and the activation or deactivation state of the solar unit 1 or the light sensor 16 respectively, is plotted on the y-axis. A regular day starts at the time t1, and during the day phase (time t1 to t2), the activation state of the solar unit 1 or the light sensor 12, respectively, is detected by the measuring device 10 as indicated by the arrows PT and is fed to the locating device 7 or to the transmitter 8, respectively, by the CPU 10 in the form of a non-stacked signal. During the following night phase t2 to t3, the deactivation state of the solar unit 1 or of the light sensor 16, respectively, is detected by the measuring device 10 and a corresponding deactivation signal is fed to the CPU 12 according to the arrows PD. This period t1 to t3 corresponds to a regular daily cycle when the container is not stacked.

The next daily cycle begins at the time t3, for example, during which, at the time t4, the container is stacked. The activation state (arrow PT) indicated by the measuring device 10 during the interval t3 to t4 is interrupted at the time t4, when the container is stacked. This means that the deactivation state of the measuring device 10 is indicated according to the arrows PD, and the deactivation signal is fed to the CPU 12. When this deactivation state lasts longer than a specified time, preferably longer than 24 hours, the “container stacked” state is determined by the CPU 12 at the time t5 because the solar unit 1 or the light sensor 16, respectively, has indicated the deactivation state for longer than the regular night phase. A corresponding stacked signal PG is generated by the CPU 12 and is supplied to the locating device 7. To be able to save energy, the GPS receiver 9 of the locating device 7 is preferably turned off by the stacked signal indicating the stacked state at the time t5. With a high degree of probability, no GPS signal is expected in the stacked state anyway. Thus, the battery is not discharged unnecessarily.

If thereafter at the time t6 the container is removed from the stack during stevedoring and then re-stacked at the time t7, the activation state is detected by the measuring device 10 at the time t6, and the non-stacked signal is transmitted by the CPU 12 to the locating device 7; its transmitter 9 sends the message “Container non-stacked”, as indicated by the arrow PF. When the deactivation state is detected after re-stacking at the time t7, the stacked signal (arrow PG) is generated by the CPU 12 and supplied to the locating device 7 after a period t7 to t8, which preferably is again 24 hours.

After re-stacking at the time t8, the GPS receiver 9 is again turned off for energy saving purposes.

Finally, at the time t9, for example, after renewed unstacking of the container for continued transport, the activation state is detected by the measuring device 10 and the CPU 12 again sends the non-stacked signal PF. Normal operation corresponding to the time t1 to t2 starts again.

The switching threshold for light detection is defined via the software in the CPU 12, preferably in such a manner that the artificial light of typical cranes and transporting devices at night is sufficient for detecting the activation state or the “Container non-stacked” state, respectively. This ensures that the respective message can be transmitted to the monitoring center even when unloading takes place at night. Otherwise, the design of typical containers and the usually blackened bottom area ensure that the daylight that strikes the solar unit of the present device of a stacked container is suppressed to the extent that the measuring device 10 does not detect daylight or the deactivation state, respectively.

### REFERENCE CHARACTERS

1 Solar unit
2 Conductor
3 Conductor
4 Charging unit
5 Conductor
6 Conductor
7 Locating device
8 Transmitter
9 Receiver
10 Measuring device
11 Conductor
12 CPU
13 Conductor
14 Conductor
15 Conductor
16 Light sensor
17 Conductor
17′ Conductor
18 Conductor
18° Conductor

What is claimed is:

1. A device for detecting the stacking state of a container using a solar unit that is connected to a charging unit that feeds a transmitter and a receiver, whereby the transmitter communicates with a remote monitoring center, the improvement comprising a measuring device that serves as a light indicator and generates an activation signal when the device is exposed to daylight, and the container is, therefore, non-stacked, and which supplies the activation signal to a CPU that transmits a non-stacked signal to the locating device; wherein the measuring device generates a deactivation signal and supplies said signal to the CPU when the device is dimmed wherein the CPU transmits a stacked signal indicating the stacked state of the container to the transmitter, when the measuring device detects that the device is dimmed for a longer period than the normal dim-out during the night and wherein the transmitter transmits a signal corresponding to the stacked state or the non-stacked state, respectively, to the monitoring center.

2. A device as set forth in claim 1, wherein the measuring device is supplied with electrical current from the charging device and derives the activation state of the solar unit from the output signal of the activated solar unit.

3. A device as set forth in claim 1, wherein the measuring device is supplied with electrical current from the charging device and derives the activation state of the solar unit from the output signal of a light sensor.

4. A device as set forth in claim 3, wherein the light sensor is located in the area of the solar unit.

5. A device as set forth in claim 1, wherein the receiver and the transmitter are part of a locating device.

6. A device as set forth in that claim 1, wherein the CPU generates the stacked signal when the measuring device generates the deactivation signal for longer than twenty-four hours.

7. A device as set forth in claim 1, wherein the switching threshold for detecting the activation state is defined such that the measuring device generates the activation signal even when at least one of the solar unit and the light sensor, respectively, captures the artificial light that is typical for work at night.

8. A device as set forth in claim 1, wherein the CPU is a low power micro-controller.

9. A device as set forth in claim 1, wherein the receiver is turned off for the purpose of saving energy when the stacked signal is generated.

10. A device as set forth in claim 1, wherein the receiver is a GPS receiver.

11. A device as set forth in claim 1, wherein the charging device includes a battery for storing energy.

12. A method for detecting the stacking state of a container, with a device as set forth in claim 1, said method comprising the steps of: capturing the activation state and the deactivation state of a solar unit of the device using a measuring device; generating a non-stacked signal indicating the non-stacked state of the container when the measuring device captures the activation state of the solar unit when it is struck by at least one of sunlight and daylight, respectively and generating a stacked signal indicating the stacked state of the container when the deactivation state of the solar unit is captured upon dim-out for a longer period than corresponds to the deactivation state of a regular night phase.

13. A method as set forth in claim 12, wherein the device is attached in a groove of the upper wall of the container.
